(19) United States
(12) Patent Application Publication
(10) Pub. No.: US 2017/0067492 A1
(43) Pub. Date: Mar. 9, 2017

(54) LOCKING SYSTEM FOR AN ACTUATING CYLINDER AND AN ACTUATING CYLINDER

(71) Applicant: Luciano Trindade de Sousa Monteiro, Sao Paulo (BR)

(72) Inventor: Luciano Trindade de Sousa Monteiro, Sao Paulo (BR)

(21) Appl. No.: 15/149,912

(22) Filed: May 9, 2016

(30) Foreign Application Priority Data
Sep. 8, 2015 (BR) BR102015021963-6

(51) Int. Cl. F15B 15/26; F15B 11/08

(52) U.S. Cl. CPC F15B 15/26; F15B 11/08

(57) ABSTRACT

Provided is a locking system for an actuating cylinder comprising a substantially cylindrical barrel provided with an internal cavity and an inner perimeter, a first cap associated to a first end of the barrel, the inner perimeter of the barrel exerting contact with the first cap, a second cap fixed at a second end opposite the first end, the inner perimeter of the barrel exerting contact with the second cap, wherein the barrel comprises at least one barrel recess adjacent to at least one of the ends, the first and the second caps comprise at least one cap recess, said at least one barrel recess is aligned with said at least one cap recess, forming a channel, the barrel is further provided with an access opening arranged tangentially to the channel and configured to receive a lock ring configured to establish locking between the barrel and at least one cap.

### CROSS-REFERENCE TO RELATED APPLICATIONS

This application claims priority to and the benefit of Brazilian Patent Application Serial No. BR102015021963-6, filed Sep. 8, 2015, the contents of which as are hereby incorporated by reference in their entirety.

### BACKGROUND

### Technical Field

The present invention relates to a system applicable to a force linear actuator cylinder that promotes locking of one or both ends of the actuator cylinder by means of a steel locking ring, thus enabling an effective, rapid and low-cost cylinder mounting.

### Related Art

Pressure linear actuating cylinders are mechanical devices that use a pressurized fluid (either liquid or gaseous) to apply a force in a linear stroke. In general, they are composed by a cylindrical barrel body associated to two closing caps at their ends, a fluid-blocking bottom base and, on the opposite side, another fluid-blocking base through which a piston with actuating rod passes, this base having also the function of guiding the piston.

As to the functioning of an actuating cylinder, the latter varies according to the application. There are actuating cylinders that have the function of force actuators and that have pressure-controlling means, which results in controlling the actuation force exerted in the movement of the piston or rod. There are also cylinders that act as shock-absorbers, making use of a controller of flow-rate of the compressible fluid in order to absorb the impacts of the forces applied to the piston rod.

As to the manufacture of the cylinders, the fixation of the closing base to the barrel may be carried out in an equal or different way on both caps, in various manners comprised by the present prior art. A manner usually adopted with low-pressure cylinders is that illustrated in FIG. 1. One can see a barrel 220 that houses at its end (rod region), the guide of the rod 240, through which the piston with rod 235 passes.

One can see that the rod guide 240 is blocked by a turned edge at the barrel 220, so that the ends (borders) of the barrel 220 are turned, thus blocking the rod guide 240.

The barrel 220 has a recess 222 at each of its ends, which limits the fitting of the rod guide 240 and of the base 250, to fix these elements inside it.

This prior-art closing configuration is used for the sake of easy mounting, the latter being reduced basically to the step of folding the barrel 220. However, a problem resulting from the use of this type of closing is the low work-pressure admitted into the cylinder, since the closing is foreseen only by the short extent of fold of the two ends of the barrel 220. Such a fold imparts little resistance to the closing of the assembly and, as a result, bears a low maximum work pressure.

Another closing manner adopted at present is that illustrated in FIG. 2, which shows a prior-art cylinder. The closing of the upper end of the barrel 220 takes place by means of a locking ring of rounded cross-section 260, a gap 241 present in the barrel 220 and in the rod guide 240. On the other hand, the bottom-closing base exhibits a soldering of the components of the barrel 220 with the base 250 of the closing bottom. This configuration illustrated in FIG. 2 results from an expensive manufacture process , wherein the closing of the lower part has an additional problem upon use of difficult-to-block gases, as for example nitrogen, in which case it is necessary to control and eliminate any porosity.

Additionally, the soldering process 251 is relatively complex to carry out and demands time and means that may represent part of the manufacture process like a canopy, in which case it is necessary to provide specific facilities and materials. Besides, the finish of poor quality that results from the soldering process requires further finishing work after the soldering process, increasing even more the expenditures with the process.

The prior art further comprises a configuration as illustrated in FIG. 3, which shows a barrel 220 that is also closed by a rod guide 240 locked on the barrel 220 with a lock that is a shaped recess. A similar process takes place with the bottom lock 250. In this case, the locking takes place by means of recesses 223 formed and embedded into the barrel 220 with appropriate equipment, the inner protrusion of which is housed in a recess existing in the rod guide 240, and in a similar way in the bottom base 250.

In the case of the configuration illustrated in FIG. 3, there are also various problems. First, this type of locking exhibits low resistance limits and, as a result, there is the possibility of dissociation between the parts involved in the locking (rod guide 240, base 250 and barrel 220). Moreover, the application of this configuration requires specific equipment for deformation of the barrel 220, requiring further means for manufacturing the assembly.

Thus, one understands that the prior art does not comprise a locking system that enables good internal work pressure for the actuating cylinder and simultaneously promotes a practical and cost-saving process of manufacturing the cylinder.

### BRIEF SUMMARY

Considering what has been set forth above, the present invention has the objective of providing a locking system for an actuating cylinder which imparts to the cylinder greater resistance to the internal pressure and, as a result, high reliability, and still enables the use of cylinders having greater pressure and force capacity.

It is also an objective of the invention to provide a locking system for an actuating cylinder that facilitates the mounting of the cylinder itself, promoting a time-and-cost-saving process.

A further objective of the invention is to provide a locking system having a constructive configuration that is practical and has easy conception, enabling considerable cost-saving in the process of making the cylinder.

The present invention relates to a locking system for an actuating cylinder, the cylinder comprising a substantially cylindrical barrel having an inner cavity of an internal perimeter, a first cap associated to the first barrel end, the internal perimeter of the barrel having contact with the first cap, a second cap fixed to a second end opposite the first end, the internal perimeter of the barrel having contact with the second cap.

The barrel comprises at least one barrel recess adjacent to at least one of the ends, the first and the second caps comprising at least one cap recess, said at least one barrel recess being aligned with said at least one cap recess forming a channel.

The barrel is further provided with an access opening located tangentially to the channel and configured to receive a locking ring that extends along the extent of the channel and configures the locking between the barrel and at least one cap.

Particularly, the first cap is provided with at least one first gap that receives a scraping ring, a second gap that receives a static sealing element, and a third gap that receives a dynamic sealing element. Preferably, the dynamic sealing element is a gasket.

Further, the second cap is provided with at least one gap that receives a static sealing element, the latter being preferably an “O-ring”. The channel has geometry substantially similar to that of the locking ring, so that it integrally fits in with the recess, and the cap recess and the barrel recess have similar profile.

Additionally, the cap recess and the barrel recess have, preferably, semicircular profile, the second cap being provided with a filling valve, and the first cap and the second cap being provided with a support protrusion, that latter being provided with a flap that prevents deformation of the barrel.

### BRIEF DESCRIPTION OF THE SEVERAL VIEWS OF THE DRAWING(S)

The present invention will now be described in greater detail with reference to an example of embodiment represented in the drawings. The figures show:

FIG. 1—a cross-sectional front view of a prior-art actuating cylinder with a locking system by folding at the barrel ends;

FIG. 2—a cross-sectional front view of a prior-art actuating cylinder with a locking system by welding, and a metal ring housed in recesses in the junction of the components;

FIG. 3—a cross-sectional front view of a prior-art actuating cylinder with a locking system by deformation in the shape of a ring embedded in the perimeter of the component junction;

FIG. 4—a cross-sectional front view of the actuating cylinder of the present invention;

FIG. 5—representation of the A-A section referred to in FIG. 4;

FIG. 6—representation of the B-B section referred to in FIG. 4;

FIG. 7—a detail of the gap that receives the locking ring;

FIG. 8—a detail of the access opening of the lock in the barrel of the actuating cylinder of the present invention;

FIG. 9—a cross-sectional front view of an alternative constructive embodiment of the actuating cylinder of the present invention;

FIG. 10—representation of the C-C section referred to in FIG. 9;

FIG. 11—representation of the D-D section referred to ion FIG. 9;

FIG. 12—a detail of the access opening of the alternative constructive embodiment of the actuating cylinder of the present invention.

One should observe that the reference numbers in the drawings correspond from 1 to 199 to parts or items according to the present invention, and from 200 onward to parts and items referred to in the present-day prior art.

### DETAILED DESCRIPTION OF VARIOUS EMBODIMENTS

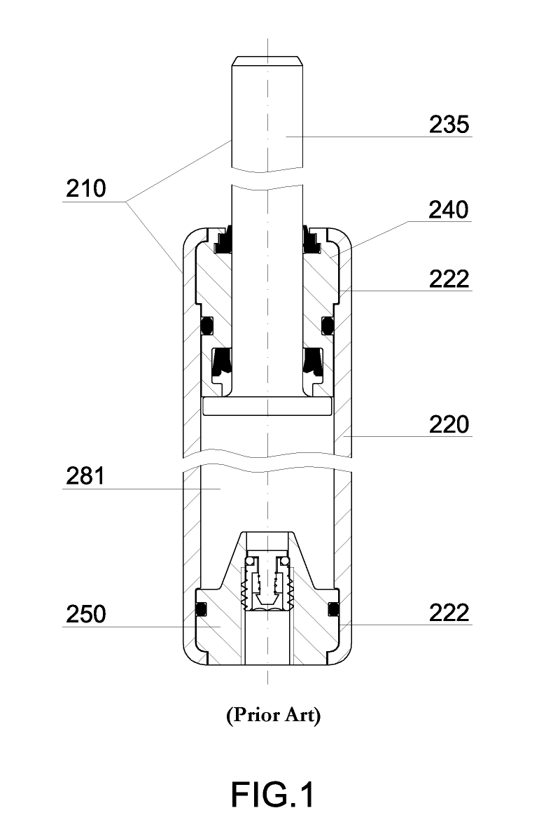

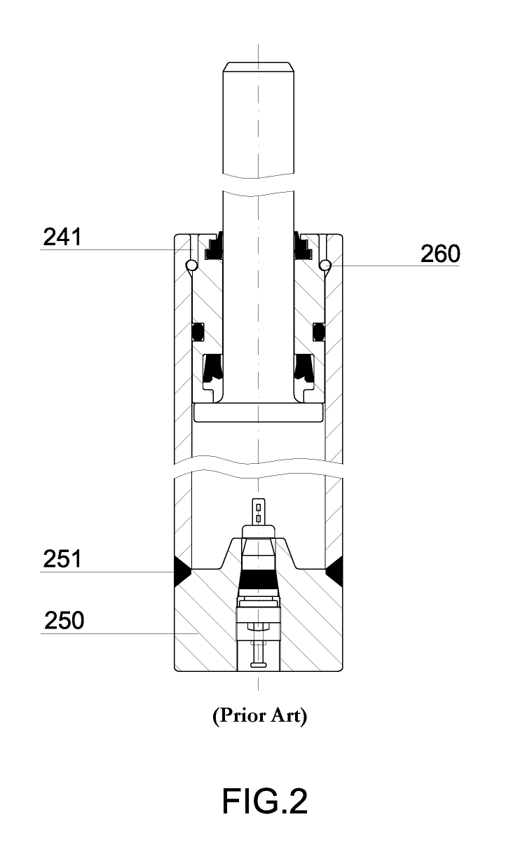

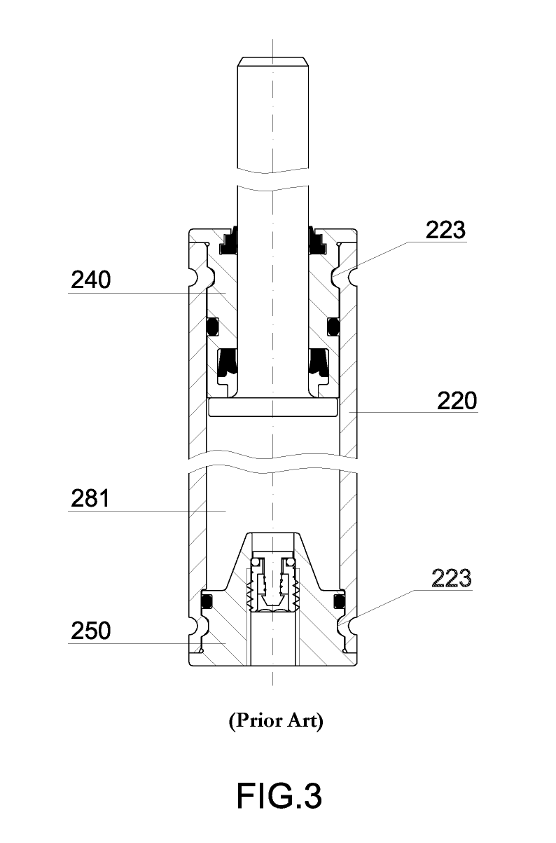

As already presented before, FIGS. 1, 2, and 3 describe actuating cylinders comprised by the prior art and that make use of cylinder-lock systems by folding, soldering, metallic ring or deformation, having some problems that affect the cost of manufacturing the actuating cylinder itself and/or its maximum work-pressure capacity in the respective constructive forms.

It should be noted that, in order to enable easy distinction between the prior-art elements and those of the present invention, the reference numbers in the drawings from 1 to 199 correspond to the elements referred to in the present invention, and those above 200 correspond to the present-day prior art.

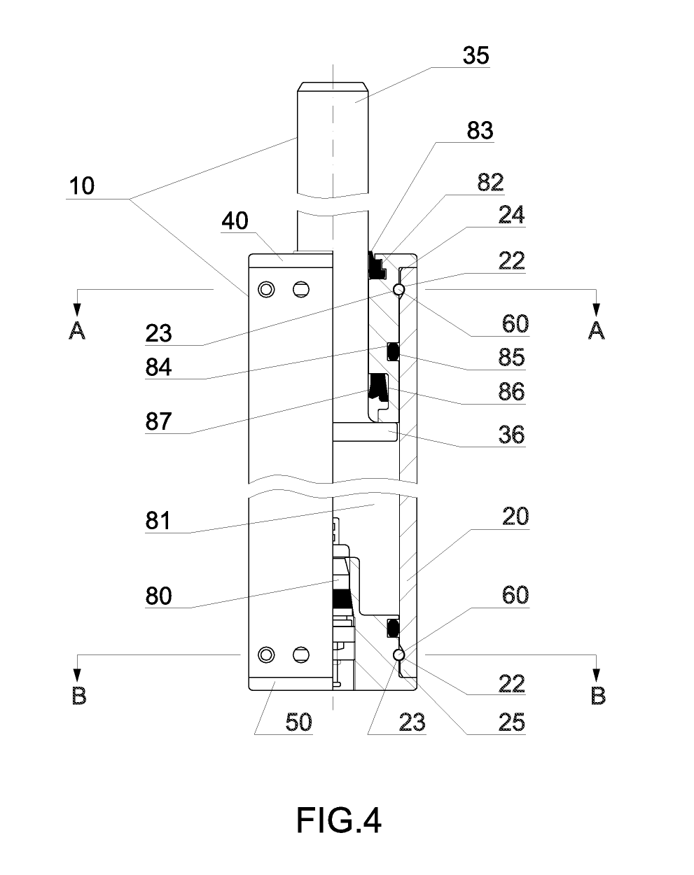

FIG. 4, in turn, shows a cross-sectional front view of the actuating cylinder 10 which is the object of the present invention. Said cylinder 10 comprises a barrel 20 substantially cylindrical, provided with a first end 24 close to the rod, and a second end 25 opposite the first end 24. These ends 24, 25 should be closed with respect to the external environment, so as to close the internal cavity of the cylinder, enabling it to contain and store a pressurized fluid inside the cylinder 10.

Various types of pressurized fluid may be applied to the cylinder 10, as long as, upon choosing the fluid, one takes into consideration the best adaptation to the application for which it is intended. Factors like maximum load capacity, operation risk and necessary accuracy influence the choice of the adequate fluid. We can cite, as applicable fluids, air, oil, gases, nitrogen, among others, reminding again that the application is not limited to these.

In order to carry out the closing of the ends 24, 25 and, as a result, the closing of the internal cavity 81 of the barrel 20, the system of the present invention uses a first cap 40 and a second cap 590, arranged at the ends 24, 25 of the cylinder 10. The first cap 40 is preferably a rod guide 40 and the second cap 50 is preferably a bottom base 50.

In this preferred constructive embodiment, one observes that the rod guide 40 is associated to the first end 24. In turn, the bottom base 50 is associated to the opposite second end 25.

One further observes in FIG. 4 that the rod guide 40 is associated to a piston 35 with a rod head 36, the latter being configured to move axially and selectively upon pressurization of the actuating cylinder 10. On the other hand, one observes that the bottom base 50 is fixed, preferably exhibiting, at its distal end, a filling valve 80, which acts as an exhaust valve as well.

The filling valve 80 is configured to enable selectively the passage and interruption of pressurized fluid from an external source toward an internal fluid-storing cavity 81, such internal cavity 81 exhibiting a volume between the rod guide 40 and the bottom base 50.

It is further noted that the rod guide 40 is provided with at least a first gap 82 to house a scraping ring 83, a second gap 84 to house a static sealing element 85, such as an “O-ring” in static position, the latter being configured to block the fluid inside the internal cavity 81, and still in the innermost part a third gap 86 to house a dynamic sealing element 87, the latter being more usually a gasket, the closing bottom base 50 being also provided with at least one gap 84 to house a sealing element 85, in which case one uses preferably an “O-ring”, since this is a static condition.

Once the closing of the actuating cylinder 10 has been described, one can notice that this preferred embodiment is directed to a pressure or force-actuating cylinder, which is filled with a pressurized fluid that should be a compressible gas, such as nitrogen gas, by means of the filling valve 80 arranged at the bottom base 50.

However, it should be noted that the present invention can be applied to the most varied types of cylinder embodiments, such as embodiments in which the filling valve is housed at the external end of the cylinder rod, and still other embodiments, usually applied to disposable low-pressure cylinders, wherein the cylinder does not exhibit filling valve, being cylinders mounted with pre-defined work-pressure.

The piston 35 is associated to any outer contact surface that needs defined actuation or holding force, which, after having been achieved, in the case of compressible gases, gives way with the increase in compression of the gas inside, and in the case of non-compressible fluids, gives way with the transfer of fluid into another reservoir. After the force actuation has stopped, the compressible fluids tend to return to their original volume, and the non-compressible ones return by pump action, and in both cases they push the piston, leading the actuating cylinder 10 back to its initial state.

Although one used, in the preferred embodiment described herein, two caps 40, 50, one being a rod guide 40 and the other being a bottom base 50, for closing the barrel 20 of the actuating cylinder 10, one notes that it is evident that the barrel 20 may have its lower end closed by a base integral with the barrel 20 as a single piece. In this scenario, the cavity is created inside the barrel 20, the latter being machined or shaped from a cylindrical billet.

Moreover, it is evident that the use of the system of the present invention is not limited to force actuating cylinders alone, it being also possible to use cylindrical components having constructive characteristics that differ from those described herein, such as, for example, a shock-absorbing cylinder or still a bottom base 50 without a filling valve, configuring a fluid-compression cylinder, or else the use of two closing bases without a rod, configuring a reservoir-cylinder.

The closing or association of both ends 24, 25 by their respective caps 40, 50 takes place by means of the locking system of the present invention.

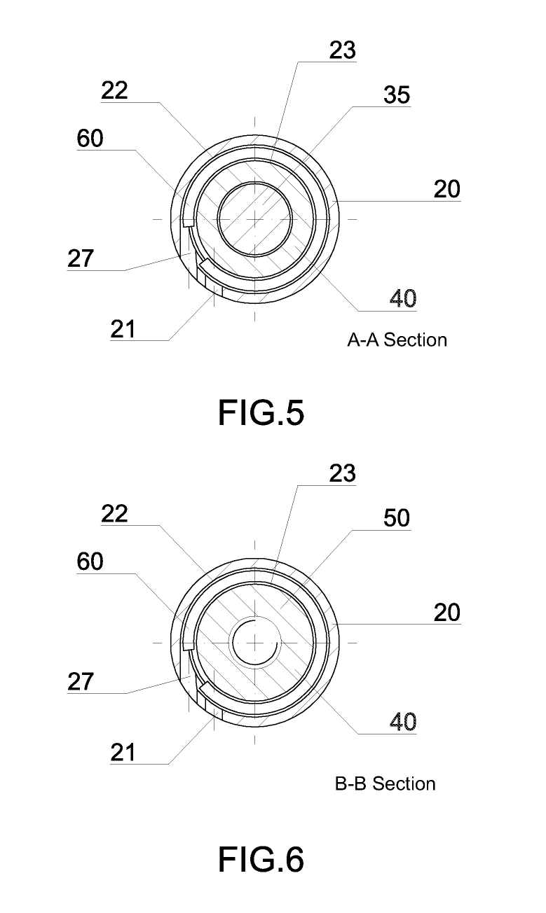

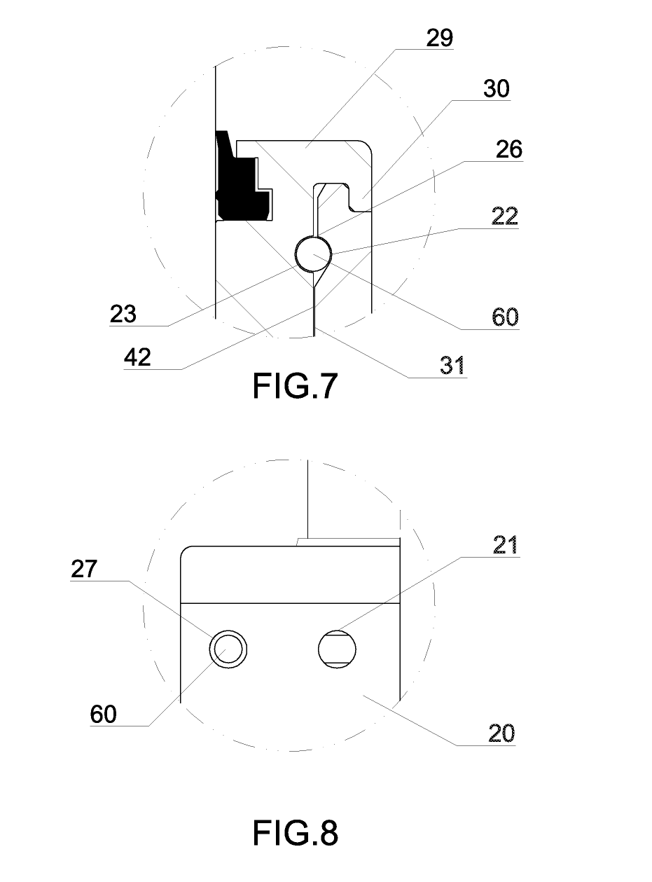

In FIG. 4, and in greater detail in FIGS. 5, 6, and 7, one can observe that the barrel 20 is provided, in the internal part, with at least one barrel recess 22 for each element to be locked in the barrel 20 and arranged adjacent to at least one of the ends 24, 25 of the barrel 20. The barrel recess 22 is arranged to be aligned with a cap recess 23 present ion the rod guide 40 and/or bottom base 50.

The barrel recess 22 preferably comprises a semicircular profile, although it may have a compatible shape, such as semi-rectangular, and is provided, in the inner perimeter 31, with the barrel 20 juxtaposed to the outer perimeter 42 of the rod guide 40 and adjacent to the ends of the barrel 20. The cap recess 23 comprises a profile substantially analogous to the barrel recess, and its alignment configures a channel 23, the geometry of which is the union of both recesses 22, 23. In the case of this preferred embodiment, the semicircular recesses will configure a circular profile for the channel 26. More specifically, the center line of the channel 26 corresponds to the contact tangency of its corresponding cap 40, 50.

Thus, one observes that both ends 24, 25 and caps 40, 45 may be provided with recesses 22, 23 that configure channels 26 at the upper and lower ends 24, 25 of the barrel 20, especially when the bottom base 50 is not integrated in the form of a single body or even soldered to the barrel 20. More specifically, the lower end 25 and the bottom base 50 may or may not configure a channel 26 by means of recesses.

In FIGS. 5, 6, and 7 one can see that the barrel 20 is further provided with an access bore 27 positioned in the tangency center line of the channel 26. This access bore 27 passes through the barrel 20 wall and is connected to the channel 26 with the internal region of the actuating cylinder 10. In the present preferred embodiment, this access bore 27 has a cylindrical cross-section like a channel 26 for mounting compatibility.

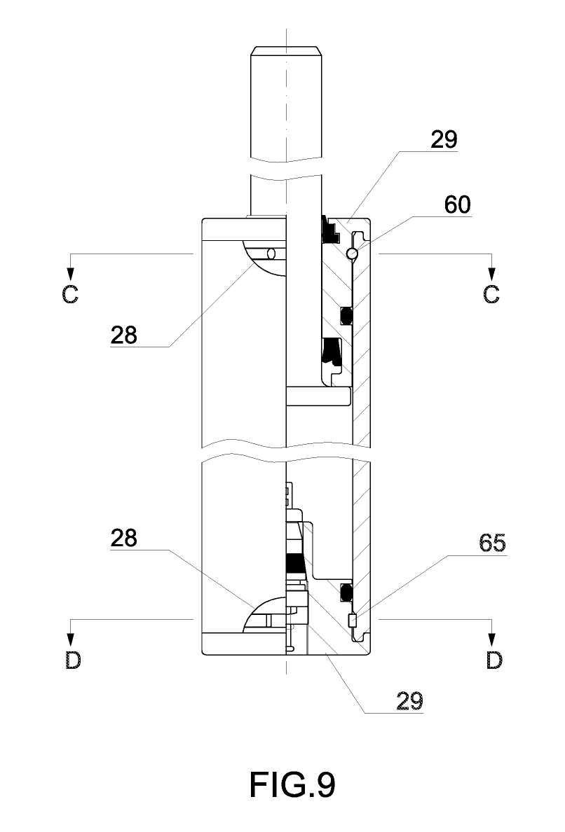

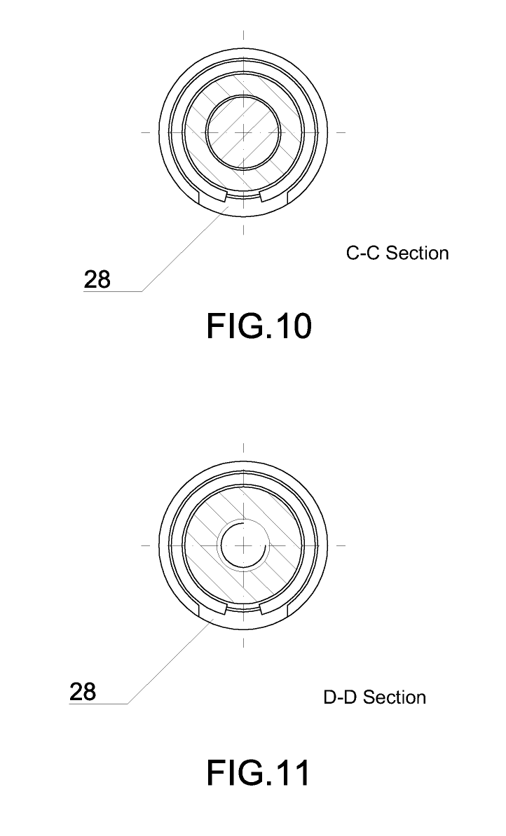

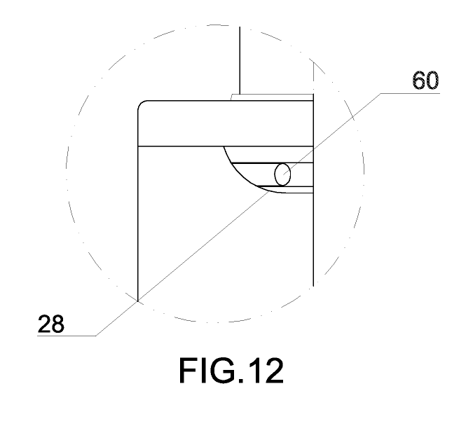

However, it should be noted that the access bore may be configured with other profiles, as long as they enable the access opening 27 to be adjacent to the channel 26 and enables connection between the external region of the actuating cylinder and the gap. FIGS. 9, 10, 11 and 12 show details of an alternative embodiment of the present actuating cylinder, presenting a barrel 20 provided with an access opening 28 in the form of a semicircle, serving, in this case, view the positioning of the lock ring 60.

Moreover, the barrel 20 may also exhibit, preferably, an inspection bore 21 adjacent to the access opening 27 for viewing and aiding in mounting the lock ring 60. One observes that the access opening 28 is arranged tangent to the channel 26 of the lock ring 60 and connects the external region of the cylinder to said channel 26, in a similar way as in the preferred embodiment described before.

This having been said, the association/locking of the barrel 20 with the caps 40, 50 is provided by the insertion of a steel lock ring 60 into the channel 26 through the bore 27. The lock ring 60, in a preferred embodiment, being made from resistant, but malleable metallic materials, such as specific steel and chrome alloys, usually known as spring-steels. The lock ring 60 has, preferably, cross-section substantially similar to the profile of the channel 26 and such a length that involves almost the whole inner perimeter 31 of the barrel 20, as shown in FIGS. 5 and 6. Markedly, the lock ring 60 may have cross-section geometry different from that of the channel 26, as long as it enables effective association between the barrel 20 and the respective caps. Further, the profile of the channel 26 is configured to enable perfect housing of the lock ring 60.

After insertion of the lock ring 60 into the channel 26, the caps 40, 50, remain locked with respect to the barrel 20, thus closing the actuating cylinder 10 and enabling retention of the pressurized fluid. Preferably, one uses sealing elements during the mounting to aid in the retention. Any force that tends to move the caps 40, 50 in the axial longitudinal direction of the barrel 20 will be blocked by the lock ring 60, until its shearing limit. Evidently, the resistance of the assembly to the pressure imposed on the actuating cylinder 10 will be limited to the characteristics of the lock ring 60, such as its length, diameter and material, among other characteristics.

Alternatively, the caps 40, 50 may be provided with a support protrusion 29 to aid in mounting the assembly. This support protrusion 29 rests on the respective ends 24, 25 of the barrel 20, so that the recesses 22, 23 of the barrel 20 and recesses of the cylindrical component will be in opposition to each other, forming the channel 26 for the lock ring and in the same height as the access opening 28, thus enabling one to insert the lock ring 60 easily. It should be noted that this constructive aspect is merely optional, since the absence thereof will not prevent the invention from achieving the technical effect proposed.

Optionally, this support protrusion 29 may also have a crown in the form of a flap 30 with the function of blocking the deformation of the broadening defoliation of the barrel 20 nozzle.

In view of the foregoing, it is evidenced that the locking system of the present invention enables a considerable resistance of the actuating cylinder 10 to the internal pressure to which it is subjected, since the steel lock ring 60 is confined inside the channel 26, unlike a prior-art configuration of a metallic ring, as described before, which has a gap open to the outside of the cylinder, allowing the ring to escape. In this way, the maximum resistance to the internal pressure is dictated by the dimensions and the material of the still lock ring 60.

Also, the superior ease of manufacturing and mounting the cylinder 10 assembly becomes obvious, since there is no need for soldering and, as a result, further finish work or specific machines for locking the cylinder 10, it sufficing to place the steel lock ring 60 in the channel 26 through the bore 27 of the access opening 28.

A preferred example of embodiment having been described, one should understand that the scope of the present invention embraces other possible variations, being limited only by the contents of the accompanying claims, which include the possible equivalents.

1. A locking system for an actuating cylinder (10), the locking system comprising:
a cylinder (10) comprising:
a substantially cylindrical barrel (20) provided with an internal cavity (81) and an inner perimeter (31);
a first cap (40) associated to a first end (24) of the barrel (20), the inner perimeter (31) of the barrel (20) exerting contact with the first cap (40); and
a second cap (50) fixed at a second end (25) opposite the first end (24), the inner perimeter (31) of the barrel (20) exerting contact with the second cap (50),
wherein:
the barrel (20) comprises at least one barrel recess (22) adjacent to said at least one of the ends (24, 25);
the first and the second caps (40, 50) comprise at least one cap recess (23), said at least one barrel recess (22) being aligned with said at least one cap recess (23), forming a channel (26); and
the barrel (20) is further provided with an access opening (28) positioned tangentially to the channel (26) and configured to receive a lock ring (60) that extends along the length of the channel (26), the lock ring (60) being configured to establish locking between the barrel (20) and at least one cap (40, 50).

2. The system according to claim 1, wherein the first cap (40) is provided with at least one first gap (82) that receives a scraping ring (83), a second gap (84) that receives a static sealing element (85), and a third gap (86) that receives a dynamic sealing element (87).

3. The system according to claim 2, wherein the dynamic sealing element (87) is a gasket.

4. The system according to claim 1, wherein the second cap (50) is provided with at least one second gap (84) that receives a static sealing element (85).

5. The system according to claim 2, wherein the static sealing element (85) is an “O-ring”.

6. The system according to claim 1, wherein the channel 26 has geometry substantially similar to that of the lock ring (60) and configuring a perfect housing for accommodating the lock ring (60), the channel (26) being configured to result in the recesses (22, 23).

7. The system according to claim 1, wherein the cap recess (23) and the barrel recess (22) comprise a semicircular profile.

8. The system according to claim 1, wherein the cap recess (23) and the barrel recess (22) comprise a semi-rectangular profile.

9. The system according to claim 1, wherein the second cap (50) is provided with a filling valve (80).

10. The system according to claim 1, wherein the first cap (40) is provided with a support protrusion (29).

11. The system according to claim 1, wherein the second cap (50) is provided with a support protrusion (29).

12. The system according to claim 10, wherein the support protrusion (29) is provided with a flap (30), the flap (30) being configured to prevent deformation of the barrel (20).

13. An actuating cylinder (10), characterized by comprising a system as defined in claim 1.
